(19) United States
(12) Patent Application Publication
(10) Pub. No.: US 2009/0219849 A1
(43) Pub. Date: Sep. 3, 2009

(54) APPARATUS FOR AND METHOD OF MULTICAST AND BROADCAST SERVICE (MBS) MACRO-DIVERSITY BASED INFORMATION PROCESSING

(75) Inventors: Yaron Alpert, Hod Hasharon (IL); Jonathan Segev, Tel Mond (IL); Erez Ben-Tovim, Ra'anana (IL); Jacob Scheim, Pardes Hanna (IL)

Correspondence Address: Zaretsky Patent Group PC, 20783 N 83rd Ave, Ste 103-174, Peoria, AZ, 85382-7430, US

(73) Assignee: Comsys Communication & Signal Processing Ltd.

(21) Appl. No.: 12/172,341

(22) Filed: Jul. 14, 2008

Related U.S. Application Data
(60) Provisional application No. 61/033,170, filed on Mar. 3, 2008.

(51) Int. Cl. H04H 20/71

(52) U.S. Cl. 370/312

(57) ABSTRACT

A novel and useful apparatus for and method of multicast and broadcast service (MBS) macro-diversity based information processing for use in MBS enabled wireless communication systems. MBS allocations and transmissions from base stations are not coordinated and independent of each other. The characteristics of the MBS signal, such as waveform, modulation, timing and frequency domain, used for transmissions in one or more MBS zones by a base station are uncoordinated and unsynchronized with respect to transmissions in other base stations or MBS zones. They all, however, contain the same information content and relate to the same CID (MCID and/or SA). The MS, using multiple detection techniques, uses time and frequency diversity reception techniques to combine MBS transmissions received from multiple base stations. Base stations and/or the network inform mobile stations of whether or not uncoordinated MBS data transmission is supported on the network via a TLV transmitted during the MBS connection setup process. If supported, mobile stations can receive multiple MBS data signals, combining them to generate a single MBS data output stream.

### REFERENCE TO PRIORITY APPLICATION

This application claims priority to U.S. Provisional Application Ser. No. 61/033,170, filed Mar. 3, 2008, entitled “Apparatus for and Method of Multicast and Broadcast Service (MBS) Macro-Diversity Based Information Processing,” incorporated herein by reference in its entirety.

### FIELD OF THE INVENTION

The present invention relates generally to wireless communication systems and more particularly relates to an apparatus for and method of multicast and broadcast service (MBS) macro-diversity based information processing for use in MBS enabled wireless communication systems.

### BACKGROUND OF THE INVENTION

With the huge and rapid growth of the Internet, many multimedia services have emerged, many of which require the same data to reach multiple users simultaneously, i.e. to be multicast. Examples of multicast services include video on demand, television on demand, video conference, online education, interactive games, etc.

Multicast is a well-known point-to-multipoint technique that transfers data from one data source to multiple destinations. As to broadcast services, Cell Broadcast Service (CBS) in traditional mobile networks only allows transmitting low bit rate data to all users through the shared broadcast channel of the cell. Although IP multicast techniques exist, the different characteristics of mobile networks (e.g., network structure, function entities and wireless interfaces), current IP multicast techniques are not suitable for use with mobile networks. In addition, compared with common services, mobile multimedia services typically deliver large quantities of data, have long time durations, are delay sensitivity, etc. Therefore, transmission using current techniques of broadcast services and multicast service are not suitable for efficient data transmission of mobile multimedia services.

With regard to mobile communications, next generation wireless communication is evolving into multimedia broadcast/communication systems capable of transmitting multimedia service. The multimedia broadcast service supports transmission of multimedia information such as real-time video and audio, still video, and text information and can simultaneously provide video data as well as audio data over a broadcast channel. In order to support these services efficiently, a base station (BS) multicasts and broadcasts one or more multimedia data sources to a plurality of mobile stations (MSs).

The Third Generation Partnership Project (3GPP), (a Wideband Code Division Multiple Access/Global System for Mobile Communications (WCDMA/GSM) global standardization organization) provides Multimedia Broadcast/Multicast Service (MBMS). Multicast and Broadcast Service (MBS) has been introduced recently into the IEEE 802.16e specification. MBMS service and MBS service provide the specifications of multicast in the mobile networks to enable a mobile network to provide point-to-multipoint services, thereby allowing network resources to be shared and the utilization ratio of network resources (e.g., the air interface) to be increased.

A diagram illustrating an example prior art system architecture supporting MBS service in the IEEE 802.16 specification is shown in FIG. 1. The system, generally referenced 10, comprises two overlapping MBS zones, MBS zone #1 (11) and MBS zone #2 (13), a plurality of base stations (BSs) 18, a plurality of mobile stations (MSs) 19, backbone cloud 12, one or more media server(s) 16 and MBS server 14 which is connected to the backbone 12. The MBS server, which supports the MBS service, functions (1) to act as an entry point for content providers, (2) to manage multicast data transmissions by the base stations associated with the MBS server, (3) to manage the distribution of multicast data to those base stations, and (4) to provide MBS service related functions to the mobile stations.

In system 10, the transmitter (i.e. base station), provides broadcast content data to multiple receivers (i.e. mobile stations) using a multicast scheme. The multicast scheme is a scheme in which a transmitter transmits data to multiple receivers. The communication system supporting MBS divides a broadcast service zone into multiple service zones or MBS zones (e.g., MBS zones #1 and #2 in this example). Within each MBS zone, one or more transmitters transmit MBS data to all receivers located in the corresponding MBS zone using the multicast scheme. Thus, all receivers located in each MBS zone simultaneously receive MBS data from the transmitter. One transmitter can handle more than one MBS zone and can simultaneously provide MBS to receivers located in corresponding MBS zones.

As the communication system provides an MBS service to users (or MSs), the MSs receive MBS data from the base stations using either a single base station access scheme or a multi-base station access scheme. In the single-base station access scheme, an MS receives MBS data from one BS in which the MS itself is registered. In the multi-base station access scheme, an MS receives MBS data not only from a BS in which the MS itself is initially registered, but also from other BSs.

In the single-BS access scheme, to receive MBS data, an MS is assigned to a single BS and unable to receive MBS data from other BSs. In the multi-BS access scheme, however, an MS is initially registered to one BS but can received data passively from other BSs in the common MBS zone without re-registration. The initial connection for MBS between a BS and an MS is generated through a Dynamic Service Addition (DSA) process, or a service allocation process, and the MS acquires the connection information with the BS by receiving Type/Length/Value (TLV) encoding information for data identification from the BS or BSs associated within the common MBS zone. In the macro-diversity multi-BS based case, all the BSs within the MBS zone transmit the same data in similar synchronized waveform.

The MS identifies an MBS zone based on a Connection Identifier (CID) or a Security Association (SA). The MBS zone refers to a zone where an MBS flow is available depending on the CID or the SA, i.e. a predetermined zone where the MS can receive MBS data. The BS broadcasts information on the MBS zone to MSs over a Downlink Channel Descriptor (DCD) message or other dedicated MBS messages. The MBS zone can refer to a group of BSs that use the same CID or SA to provide MBS.

Wireless networking constitutes an important component of future information technology applications. To improve the reliability of communication over the wireless channels and combat fading, diversity techniques are often used. One commonly used diversity technique is the use of multiple antennas at wireless transmitters and receivers. This exploits the spatial micro-diversity created by several antennas co-located in the same mobile device or BS. Spatial diversity, however, can also be exploited by the joint processing of signals transmitted or received by separate devices, BSs or mobile devices. This type of diversity is known as macro-diversity.

In wireless communication, macro-diversity refers to a situation where several receiver antennas and/or transmitter antennas are used for transferring the same signal. The distance between the transmitters is much longer than the wavelength or the transmitter use different antenna polarization. In a cellular network or a wireless LAN, the antennas are typically situated in different base stations or access points. The aim in employing macro-diversity is to combat fading and to increase the received signal strength in positions in between the base stations or access points or at the boundaries of a cell.

The Multicast and Broadcast Service (MBS) is a mechanism for distribution of data content across multiple base stations from a centralized media server in a manner, which takes advantage of the OFDMA PHY to support macro-diversity. Although the current 802.16e specification supports multicast and broadcast connections, it suffers from several disadvantages.

In most wireless systems, mobile stations at the edge of a cell endure poor communication qualities due to their long distance to the base station. One approach to increase the link scalability in detecting and receiving information reliability employs macro-diversity reception techniques. To overcome this defect, macro-diversity is introduced into cellular systems whereby a receiver can receive signals from surrounding base stations and extract useful signals from the received signals thus avoiding poor communication quality due to receiving signals from the single base station. Upon receiving a plurality of signals that all represent the same source content, a receiving node can employ any of a variety of techniques to select and/or combine the received data to generate a resultant received data stream that tends to more accurately track the original source content.

One major disadvantage is that, to achieve the macro-diversity effect at the mobile stations, all base stations in all MBS zones must transmit the multimedia traffic in perfect synchronization. This is because all the transmissions are sent using the same waveform, modulation, timing and frequency. This requires all base stations in the same multimedia broadcast (MBS) to transmit a synchronized PDU stream. Thus, some means for synchronizing SDU distribution, conversion to PDUs, and any process that changes the PDU transmission over the air must be the same for all base stations the same MBS zone. In many cases, however, the multicast transmissions received from multiple base stations will typically not be well synchronized to one another.

Thus, there is a need for a mechanism for providing MBS macro-diversity capability in a wireless communication system, such as cellular, etc. The MBS macro-diversity scheme should preferably be able to avoid the prior art burden of requiring perfectly synchronized MBS transmissions from all base stations in all MBS zones to the mobile stations.

### SUMMARY OF THE INVENTION

Accordingly, the present invention provides a novel and useful apparatus for and method of multicast and broadcast service (MBS) macro-diversity based information processing for use in MBS enabled wireless communication systems. The improved MBS macro-diversity mechanism of the present invention (also referred to as the MBS modified macro-diversity scheme) provides a broadcast service connection setup method for detecting and receiving MBS by a mobile station (MS) in a mobile communication system that supports traditional MBS macro-diversity.

In the MBS modified macro-diversity scheme of the present invention, MBS allocations and transmissions from base stations are unsynchronized and independent of each other. The characteristics of the MBS signal, such as waveform and modulation scheme (S), timing (T) and frequency domain (F), used for transmissions in an MBS zone by a base station are uncoordinated and unsynchronized with respect to transmissions in other MBS zones. Although the transmissions may use the same or different timing, modulation, frequency domain and waveform, they all contain the same information content. Since MBS zones are identified based on common CID (MCID) or SA list, each transmitter in an MBS zone can transmit using a different S, T, F, leaving only the relevant CID (MCID) and/or SA in common.

In operation, each mobile station depending on its location within a cell, may receive transmissions multiple BSs within the same zone and from more than one MBS zone. In this case, the MS, using multiple detection and decoding techniques, uses information from one source to aid in detecting and decoding the other sources. A combiner in the MS functions to merge the information detected from each source into a single MBS output data stream. Each received signal represents an uncoordinated MBS source and is analyzed, detected and used to construct a more reliable MBS data stream.

Base stations and/or the network inform mobile stations of whether or not uncoordinated MBS data transmissions are supported on the network via a TLV that is transmitted during the MBS connection setup process during re-association or as a broadcast message. If supported, mobile stations can receive multiple MBS data signals, combining them to generate a single MBS data output stream from multiple transmit origins.

The MBS macro-diversity mechanism provides several advantages and benefits, including: (1) more reliable MBS communications due to diversity combining; (2) eliminates the prior art requirement that all base station transmissions in all MBS zones be synchronized and coordinated, using the same waveform, timing, modulation and frequency domain; (3) improved MBS service coverage, capacity and increased link scalability in detecting and receiving information reliably especially for mobile stations located near the boundary of a cell; (4) improved MBS handover (HO) process within and between MBS zones; and (5) the ability to apply macro-diversity between different MBS zones.

The MBS macro-diversity mechanism of the present invention is suitable for use in any wireless communication system that offers MBS capabilities. For example, the mechanism is applicable to broadband wireless access (BWA) systems and cellular communication systems. An example of a broadband wireless access system the mechanism of the present invention is applicable to is the well known WiMAX wireless communication standard. The mechanism of the invention is also applicable to numerous other standards such as 3GPP (UMTS, WCDMA, HSPA, HSUPA, HSDPA, LTE), 3GPP2 (CDMA2000, EVDO, EVDV), DVB, and others.

Many aspects of the invention described herein may be constructed as software objects that execute in embedded devices as firmware, software objects that execute as part of a software application on either an embedded or non-embedded computer system running a real-time operating system such as Windows mobile, WinCE, Symbian, OSE, Embedded LINUX, etc., or non-real time operating systems such as Windows, UNIX, LINUX, etc., or as soft core realized HDL circuits embodied in an Application Specific Integrated Circuit (ASIC) or Field Programmable Gate Array (FPGA), or as functionally equivalent discrete hardware components.

There is thus provided in accordance with the invention, a wireless communication system comprising a plurality of transmission sources operative to receive a multicast and broadcast service (MBS) data stream from an MBS server and to transmit the MBS data stream in a downlink direction in one or more MBS zones, a radio resource controller coupled to the plurality of transmission sources and operative to provide unique identifiers mapped to particular broadcast/multicast services, a combiner operative to receive signals from at least two transmission sources and to generate an MBS output data stream therefrom and wherein transmissions from all the transmission sources include the same information content and are uncoordinated with respect to each other.

There is also provided in accordance with the invention, a method of providing diversity for multicast and broadcast services (MBS) in a wireless network, the method comprising the steps of receiving an MBS data stream from an MBS data source for transmission in a downlink direction, transmitting a message to mobile stations (MSs) including an indication that MBS transmissions from neighboring base stations (BSs) within the same or different MBS zones may be used for diversity reception and transmitting MBS data signals to the mobile stations from base stations within the same MBS zone, wherein transmissions in different MBS zones include the same information content without any transmit coordination requirement therebetween.

There is further provided in accordance with the invention, a method of providing diversity for multicast and broadcast services (MBS) in a wireless network, the method comprising the steps of receiving MBS data signals from a plurality of transmission sources, wherein each transmission source transmits the same information content without any transmit coordination requirement between transmission sources and combining the MBS data signals and generating an MBS output data stream therefrom.

There is also provided in accordance with the invention, a method of providing information for multicast and broadcast services (MBS) macro-diversity, the method comprising the step of sending a message comprising an indication of whether MBS transmissions from neighboring base stations (BSs) within the same or different MBS zones can be used for time and frequency diversity reception.

There is further provided in accordance with the invention, a system for macro-diversity transmission and reception of multicast and broadcast services (MBS) in wireless network comprising a transmission scheme employed by two or more base stations (BSs) in the network, a reception scheme employed by one or more mobile stations (MSs) in the network, one or more identifiers mapped to particular broadcast and/or multicast services and wherein each transmission by the base stations comprises the same information content without any transmit coordination scheme required therebetween.

There is also provided in accordance with the invention, a method of providing diversity for multicast and broadcast services (MBS) in a wireless network including a plurality of base stations, each base station assigned to an MBS zone, the method comprising the steps of each base station transmitting MBS data to one or more mobile stations in accordance with transmit characteristics associated therewith and without any synchronization between base stations and wherein all transmissions from all base station include the same information content.

There is further provided in accordance with the invention, a mobile station comprising a radio transceiver and associated media access control (MAC) operative to receive and transmit signals over a radio access network (RAN), a multicast and broadcast services (MBS) macro-diversity module comprising an MBS receiver operative to receive a plurality of MBS transmissions from a plurality of base stations (BSs) within the same or different MBS zones, wherein each base station transmits the same information content without any transmit coordination required therebetween, a combiner operative to combine the plurality of MBS transmissions and to generate an MBS output data stream therefrom and a processor operative to send and receive data to and from the radio transceiver and the MBS macro-diversity module.

### BRIEF DESCRIPTION OF THE DRAWINGS

The invention is herein described, by way of example only, with reference to the accompanying drawings, wherein:

FIG. 1 is a diagram illustrating an example prior art system architecture supporting MBS service;

FIG. 2 is a block diagram illustrating an example mobile device incorporating the MBS macro-diversity mechanism of the present invention;

FIG. 3 is a diagram illustrating an example system architecture implementing the MBS macro-diversity mechanism of the present invention;

FIG. 4 is a diagram illustrating an example MBS macro-diversity end to end system;

FIG. 5 is a diagram illustrating a general example of the MBS macro-diversity mechanism of the present invention;

FIG. 6 is a diagram illustrating frequency only MBS macro-diversity;

FIG. 7 is a block diagram illustrating an example MBS modulation, frequency and time macro-diversity receive mechanism;

FIG. 8 is a diagram illustrating an example MBS frequency and time macro-diversity receive mechanism;

FIG. 9 is a diagram illustrating a WiMAX based MBS frequency and time macro-diversity receive mechanism;

FIG. 10 is a diagram illustrating an example format of a frame including MBS-MAP and associated MBS data bursts;

FIG. 11 is a diagram illustrating an example format of an MBS-MAP/SII-ADV TLV for indicating whether time and frequency diversity reception is valid;

FIG. 12 is a flow diagram illustrating the MBS macro-diversity setup method of the present invention; and

FIG. 13 is a block diagram illustrating an example MBS capable receiver constructed in accordance with the present invention.

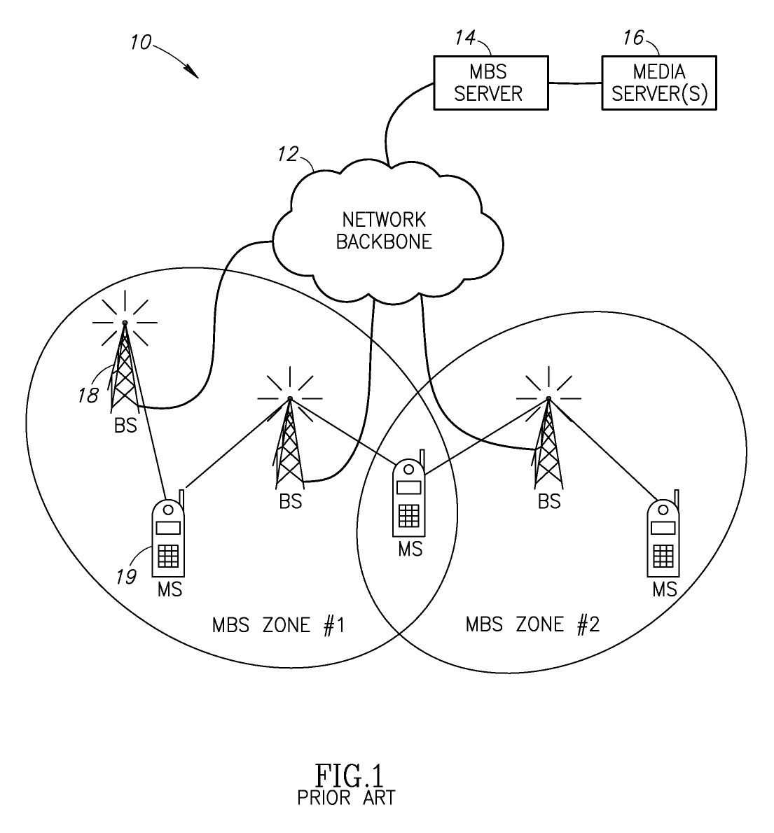

### DETAILED DESCRIPTION OF THE INVENTION

### Notation Used Throughout

The following notation is used throughout this document.

| Term | Definition |
|---|---|
| 3GPP | Third Generation Partnership Project |
| ABS | Anchor Base Station |
| AC | Alternating Current |
| ASIC | Application Specific Integrated Circuit |
| BWA | Broadband Wireless Access |
| CBS | Candidate Base Station |
| CC | Connection Context |
| CDMA | Code Division Multiple Access |
| CE | Channel Estimation |
| CID | Connection ID |
| CTC | Convolutional Turbo Code |
| DC | Direct Current |
| DCD | Downlink Channel Descriptor |
| DIUC | Downlink Interval Usage Code |
| DL | Downlink |
| DL-MAP | Downlink Medium Access Protocol |
| DSA | Dynamic Service Addition |
| EDGE | Enhanced Data rates for GSM Evolution |
| FA | Frequency Allocation |
| FDM | Frequency Division Multiplex |
| FEC | Forward Error Correction |
| FEM | Front End Module |
| FFT | Fast Fourier Transform |
| FM | Frequency Modulation |
| FPGA | Field Programmable Gate Array |
| FTDM | Frequency/Time Division Multiplex |
| GPRS | General Packet Radio Service |
| GPS | Global Positioning Satellite |
| GSM | Global System for Mobile Communication |
| HDL | Hardware Description Language |
| ID | Identification |
| IE | Information Element |
| IEEE | Institute of Electrical and Electronic Engineers |
| IP | Internet Protocol |
| LAN | Local Area Network |
| LTE | Long Term Evolution |
| MAC | Media Access Control |
| MAP | Medium Access Protocol |
| MBMS | Multimedia Broadcast/Multicast Service |
| MBS | Multicast and Broadcast Service |
| MCID | Multicast Channel ID |
| MCS | Modulation and Coding Schemes |
| MIMO | Multiple Input/Multiple Output |
| MPDU | MAC PDU |
| MRC | Maximum Ratio Combination |
| MS | Mobile Station |
| PC | Personal Computer |
| PCI | Peripheral Component Interconnect |
| PDA | Personal Digital Assistant |
| PDU | Protocol Data Unit |
| PRBS | Pseudo Random Binary Sequence |
| QAM | Quadrature Amplitude Modulation |
| RAM | Random Access Memory |
| RAN | Radio Access Network |
| RAT | Radio Access Technology |
| RF | Radio Frequency |
| RNC | Radio Network Controller |
| ROM | Read Only Memory |
| SA | Security Association |
| SBS | Serving Base Station |
| SDIO | Secure Digital Input/Output |
| SDU | Service Data Unit |
| SII | Service Identity Information |
| SIM | Subscriber Identity Module |
| SPI | Serial Peripheral Interface |
| STC | Space Time Code |
| TDM | Time Division Multiplex |
| TV | Television |
| UMTS | Universal Mobile Telecommunications System |
| USB | Universal Serial Bus |
| UWB | Ultra Wideband |
| WCDMA | Wideband Code Division Multiple Access |
| WiFi | Wireless Fidelity |
| WiMAX | Worldwide Interoperability for Microwave Access |
| WLAN | Wireless Local Area Network |

### Detailed Description of the Invention

Accordingly, the present invention provides a novel and useful apparatus for and method of multicast and broadcast service (MBS) macro-diversity based information processing for use in MBS enabled wireless communication systems. The improved MBS macro-diversity mechanism of the present invention (also referred to as the MBS modified macro-diversity scheme) provides a broadcast service connection setup method for detecting and receiving MBS by a mobile station (MS) in a mobile communication system that supports traditional MBS macro-diversity.

The MBS macro-diversity mechanism of the present invention is suitable for use in any wireless communication system that offers MBS capabilities. For example, the mechanism is applicable to broadband wireless access (BWA) systems and cellular communication systems. An example of a broadband wireless access system the mechanism of the present invention is applicable to is the well known WiMAX wireless communication standard.

To aid in illustrating the principles of the present invention, the MBS macro-diversity mechanism is presented in the context of a general MBS capable communication system, e.g., WiMAX, UMTS, LTE etc. It is not intended that the scope of the invention be limited to the examples presented herein. One skilled in the art can apply the principles of the present invention to numerous other types of communication systems as well (wireless and non-wireless) without departing from the scope of the invention.

Note that throughout this document, the term communications transceiver or device is defined as any apparatus or mechanism adapted to transmit, receive or transmit and receive information through a medium. The communications device or communications transceiver may be adapted to communicate over any suitable medium, including wireless or wired media. Examples of wireless media include RF, infrared, optical, microwave, UWB, Bluetooth, WiMAX, GSM, EDGE, UMTS, WCDMA, LTE, CDMA-2000, EVDO, EVDV, WiFi, or any other broadband medium, radio access technology (RAT), etc. Examples of wired media include twisted pair, coaxial, optical fiber, any wired interface (e.g., USB, Firewire, Ethernet, etc.). The terms communications channel, link and cable are used interchangeably. The term mobile station is defined as all user equipment and software needed for communication with a network such as a RAN. The term mobile station is also used to denote other devices including, but not limited to, a multimedia player, mobile communication device, cellular phone, node in a broadband wireless access (BWA) network, smartphone, PDA and Bluetooth device. A mobile station normally is intended to be used in motion or while halted at unspecified points but the term as used herein also refers to devices fixed in their location.

An MBS zone is defined as a zone where an MBS flow is available in accordance with a Connection Identifier (CID) or Security Association (SA). Mobile stations identify an MBS zone based on the CID or SA. The MBS zone indicates where the MS can receive MBS data. Thus, every BS in the sane MBS zone can transmit using a different scheme S, timing T and frequency F wherein the only information they have in common is the CID (MCID at MBS) and/or SA.

The word ‘exemplary’ is used herein to mean ‘serving as an example, instance, or illustration.’ Any embodiment described herein as ‘exemplary’ is not necessarily to be construed as preferred or advantageous over other embodiments.

### Mobile Station Incorporating the MBS Macro-Diversity Mechanism

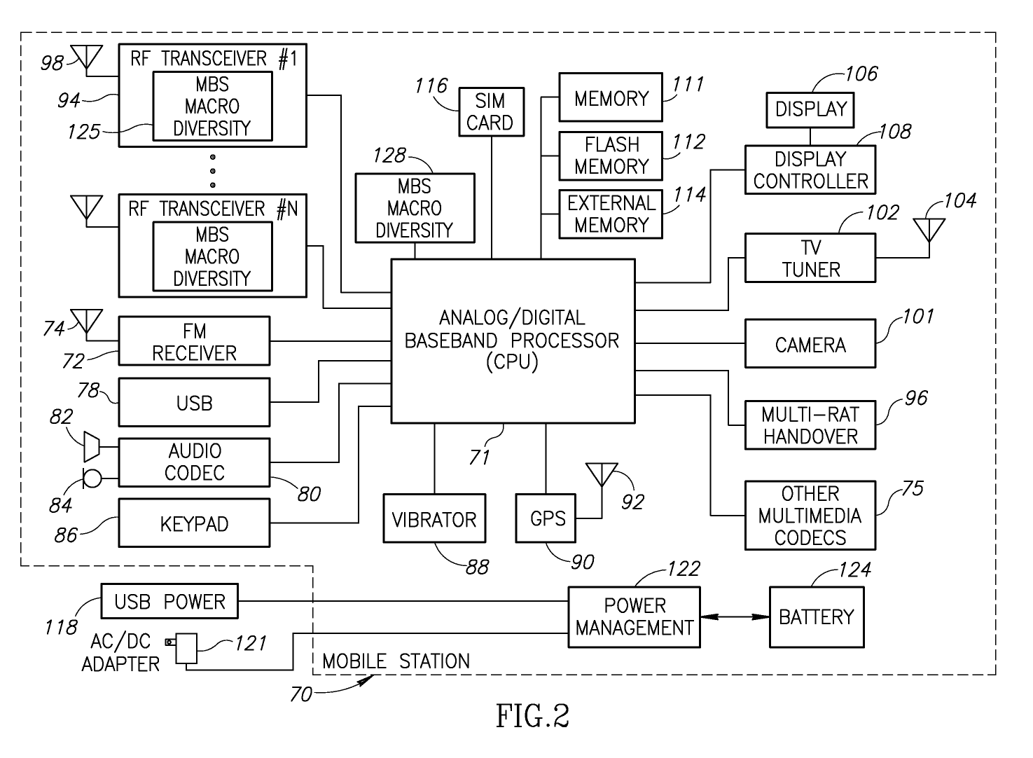

A block diagram illustrating an example mobile device incorporating the MBS macro-diversity mechanism of the present invention is shown in FIG. 2. Note that the mobile station may comprise any suitable wired or wireless device such as multimedia player, mobile communication device, cellular phone, smartphone, PDA, Bluetooth device, etc. For illustration purposes only, the device is shown as a mobile station. Note that this example is not intended to limit the scope of the invention as the MBS macro-diversity mechanism of the present invention can be implemented in a wide variety of MBS enabled communication devices.

The mobile station, generally referenced 70, comprises a baseband processor or CPU 71 having analog and digital portions. The MS may comprise a plurality of RF transceivers 94 and associated antennas 98. RF transceivers for the basic cellular link and any number of other wireless standards and RATs may be included. Examples include, but are not limited to, Global System for Mobile Communication (GSM)/GPRS/EDGE; 3G; LTE; CDMA; WiMAX for providing WiMAX wireless connectivity when within the range of a WiMAX wireless network; Bluetooth for providing Bluetooth wireless connectivity when within the range of a Bluetooth wireless network; WLAN for providing wireless connectivity when in a hot spot or within the range of an ad hoc, infrastructure or mesh based wireless LAN network; near field communications; 60G device; UWB; etc. One or more of the RF transceivers may comprise an additional a plurality of antennas to provide antenna diversity which yields improved radio performance. The mobile station may also comprise internal RAM and ROM memory 110, Flash memory 112 and external memory 114.

Several user interface devices include microphone(s) 84, speaker(s) 82 and associated audio codec 80 or other multimedia codecs 75, a keypad for entering dialing digits 86, vibrator 88 for alerting a user, camera and related circuitry 100, a TV tuner 102 and associated antenna 104, display(s) 106 and associated display controller 108 and GPS receiver 90 and associated antenna 92. A USB or other interface connection 78 (e.g., SPI, SDIO, PCI, etc.) provides a serial link to a user's PC or other device. An FM receiver 72 and antenna 74 provide the user the ability to listen to FM broadcasts. SIM card 116 provides the interface to a user's SIM card for storing user data such as address book entries, etc.

The mobile station comprises a multi-RAT handover block 96 which may be executed as a task on the baseband processor 71. The mobile station also comprises MBS macro-diversity blocks 125, 128 which may be implemented in any number of the RF transceivers 94. Alternatively (or in addition to), the MBS macro-diversity block 128 may be implemented as a task executed by the baseband processor 71. The MBS macro-diversity blocks 125, 128 are adapted to implement the MBS macro-diversity mechanism of the present invention as described in more detail infra. In operation, the MBS macro-diversity blocks may be implemented as hardware, software or as a combination of hardware and software. Implemented as a software task, the program code operative to implement the MBS macro-diversity mechanism of the present invention is stored in one or more memories 110, 112 or 114 or local memories within the baseband processor.

Portable power is provided by the battery 124 coupled to power management circuitry 122. External power is provided via USB power 118 or an AC/DC adapter 120 connected to the battery management circuitry which is operative to manage the charging and discharging of the battery 124.

### MBS Macro-Diversity Mechanism

As described supra, the present invention is a an apparatus and associated method for providing multicast and broadcast services (MBS) in a cellular, or other wireless communication system. The transmission of MBS data from multiple MBS zones is facilitated whereby the MBS transmit streams are transmitted in an uncoordinated manner with respect to each other. It is important to note that the information content of the transmissions is the same. The transmission characteristics, however, may or may be. The transmission characteristics may comprise, for example, time, frequency domain, waveform, modulation, etc. Thus, the prior art requirement of network wide synchronized transmissions in regard to signal characteristics as well as information content is eliminated. The present invention thus permits each MBS zone (or base station) to send MBS transmissions with different transmission characteristics. All transmissions do, however, have the same information content.

At the receive end (i.e. the mobile station), the information received from the various transmitters within the same or different MBS zones at different time, frequency, waveform, modulation, (i.e. [S, T, F] as defined herein), etc. are combined to generate an MBS output data stream thereby effectuating the multicast and broadcast service.

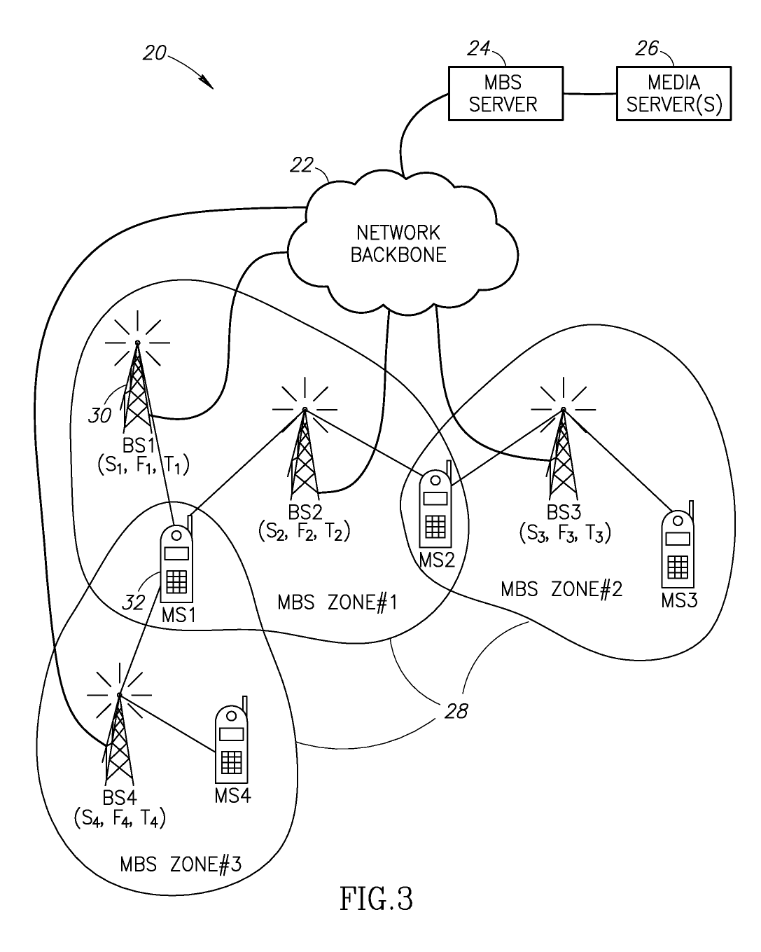

To illustrate, an example system architecture implementing the MBS macro-diversity mechanism of the present invention is shown in FIG. 3. The network, generally referenced 20, comprises a plurality of MBS zones 28, MBS ZONE #1, #2 and #3, base stations 20 (BS1, BS2, BS3, BS4), mobile stations 32 (MS1, MS2, MS3, MS4), network backbone 22, MBS server 24 and media server 26.

In this multi-zone configuration, MBS zone #1 comprises MS1, MS2 and BS1, BS2 in charge of their associated cells. In MBS zone #2, MS3 receives communication service from BS3. In MBS zone #3, MS4 receives communication service from BS4. MBS zones can overlap each other, as shown where MBS zone #2 also covers MS2 and MBS zone #3 also covers MS1. Some of the MSs are located close to a cell (MBS zone) boundary. In particular, MS1 is located near the boundary of MBS zones #1 and #3 where they overlap each other and receives communications from BS1, BS2 and BS4. MS2 is located near the boundary of MBS zones #1 and #2 where they overlap each other and receives communications from BS2 and BS3. It is assumed herein that the mobile stations MS1, MS2, MS3, MS4 may be fixed and/or mobile.

In accordance with the invention, each BS within a particular MBS zone transmits MBS data in an uncoordinated manner with respect to the other BSs using different transmission characteristics. Each BSx transmits using transmission characteristics (Sx, Fx, Tx). In particular, base station BS1 transmits using transmission characteristics (S₁, F₁, T₁), base station BS2 transmits using transmission characteristics (S₂, F₂, T₂), base station BS3 transmits using transmission characteristics (S₃, F₃, T₃) and base station BS4 transmits using transmission characteristics (S₄, F₄, T₄), where S represents the modulation and coding scheme, e.g., pseudo-random binary sequence (PRBS), F represents frequency and T represents timing.

The MSs at the edge of a cell boundary between BSs or in an overlapping coverage zone (i.e. MS1 and MS2) thus detect and receive MBS transmissions from more than one base station. In each of these MSs, the multiple receive signals are detected and using diversity techniques are combined to generate an MBS output data stream. The quality of MBS data transmission and reception is improved by the simultaneous reception of multiple radio signals by a radio interface in each mobile station. Thus, MBS services are provided to the MS at the edge of a cell with increased reliability of the received information and at a lesser system cost. System is lowered because network wide synchronization is not required.

In accordance with the invention, coordination procedures at the network level/BS level are used for coordinating and determining transmission opportunities frequency and represents the modulation and coding scheme in each BS. The coordination procedures at the network level (central unit)/BS level (distributed unit) used for coordinating and determining transmission opportunities may be based on received signal quality indication per transmission source measured by the mobile station and sent by the receiver to one of the transmitters.

### MBS Macro-Diversity System Examples

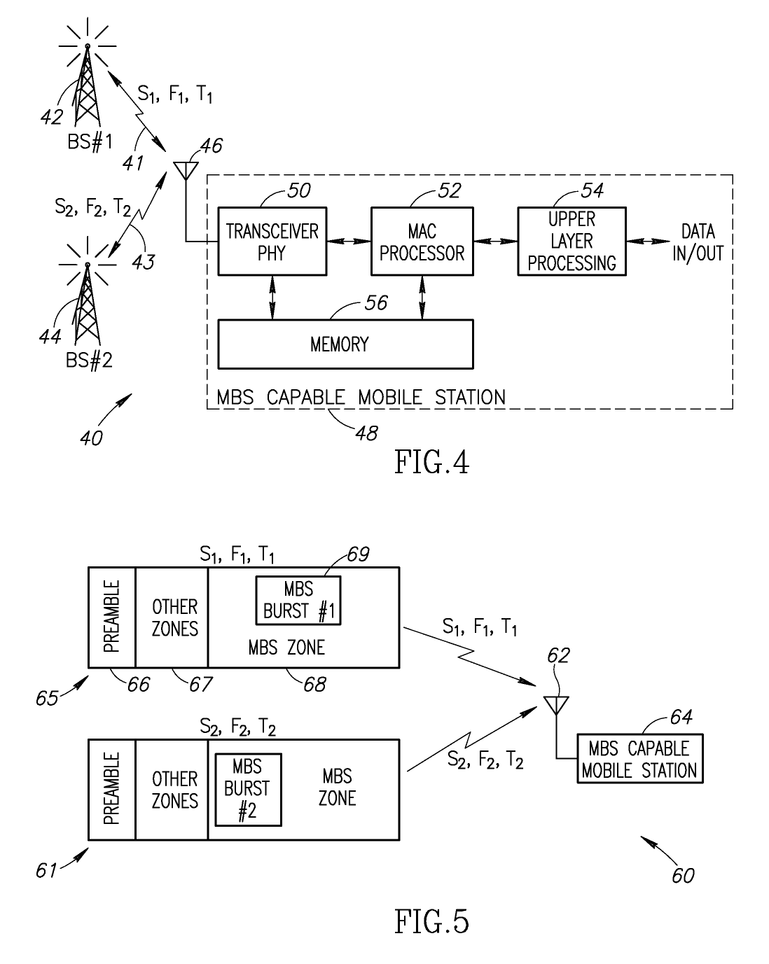

A diagram illustrating an example MBS macro-diversity end to end system is shown in FIG. 4. The system, generally referenced 40, comprises an MBS capable mobile station 48 in communication with two base stations BS #1 42 and BS #2 44. The mobile station 48, comprises a transceiver 50 coupled to antenna 46, MAC processor 52, upper layer processing block 54 and memory 56.

In operation, the mobile station is able to receive MBS transmissions (41, 43) from both the first and second base station BS #1 and BS #2, respectively, in a manner that supports the modified macro-diversity reception mechanism of the invention. This functionality and capability is facilitated through use of RF signals 41, 43 as transmitted by one (or both) of the base stations. The RF signals 41, 43 comprise an instruction, message or other indication that the mobile station is to process the corresponding MBS transmissions using standard synchronization techniques per received signal.

The base stations, BS #1, BS #2, participating in the transmission scheme, receive MBS information from an MBS source via the RAN and transmit the information using transmission scheme Sx (were ‘x’ denotes the identity of the BS, e.g., S₁ for BS #1, etc.) such the receiver (in the MS) is able to combine the signal S₁ received from BS #1 (at frequency domain F₁ with timing T₁) with the signal S₂ transmitted from BS #2 at frequency domain F₂ with timing T₂. Note that any desired combination of S, F and T may be used by each transmitter. The signal S₁ and S₂ may (1) share timing with different frequency; (2) share frequency with different timing; or (3) have different frequency and timing. S₁ and S₂ may or may not share the same modulation and coding as long as the receiver is able to combine the signals directly (e.g., RF baseband samples) or indirectly (e.g., post equalization and pre-decoding, post equalization and decoding).

Several examples of possible coordinated transmission are provided in FIGS. 5, 6 and 8 based on the IEEE 802.16 specification. Note that it is not intended that the invention be limited to use with this specification only, as the invention may be used with other communication standards that feature MBS capabilities as well.

A diagram illustrating a general example of the MBS macro-diversity mechanism of the present invention is shown in FIG. 5. The system, generally referenced 60, comprises an MBS capable mobile station 64 coupled to antenna 62. The system 60 shown, illustrates an example IEEE 802.16 specification based MBS frame transmission implementation using different scheme, frequency and timing macro-diversity.

In operation, BS #1 (not shown) transmits frame within its MBS zone 65 comprising preamble 66, other zone information 67, MBS zone 68. MBS burst #1 69 within MBS zone 68, using a transmission characteristics scheme of S₁ (i.e. coding, modulation, waveform), frequency domain F₁ and time domain T₁. BS #2 (not shown) transmits the same information content within its MBS zone frame 61 comprising a preamble, other zone information, MBS burst #2 within MBS zone, using a transmission characteristics scheme of S₂ (i.e. coding, modulation, waveform), frequency domain F₂ and time domain T₂.

The receiver (i.e. the mobile station) receives the two transmissions received from BS #1 and BS #2 and separates the two signals transmitted with S₁, F₁, T₁ and S₂, F₂, T₂ and decodes the received information to yield a single MBS data burst.

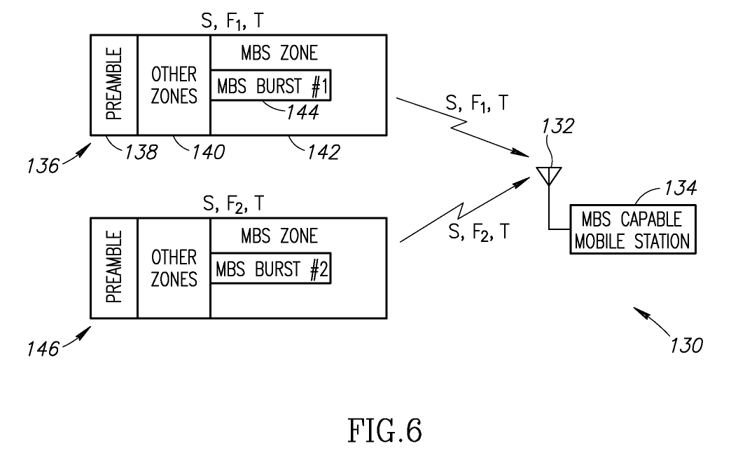

A diagram illustrating frequency only MBS macro-diversity is shown in FIG. 6. The system, generally referenced 130, comprises an MBS capable mobile station 134 coupled to antenna 132. The system 130 shown, illustrates an example IEEE 802.16 specification based MBS implementation wherein the scheme S (waveform) and timing T are coordinated (i.e. the same) while the frequencies F₁, F₂ are different.

In operation, BS #1 (not shown) transmits within its MBS zone frame 136 comprising preamble 138, other zone information 140, MBS burst #1 144 within MBS zone 142, using transmission characteristics including scheme S, timing T and frequency F₁. BS #2 (not shown) transmits the same information content within its MBS zone frame 146 comprising a preamble, other zone information, MBS burst #2 within MBS zone, using transmission characteristics including scheme S, timing T and frequency F₂. Both BS #1 and BS #2 transmit the same MBS burst, i.e. Burst #1 and Burst #2, respectively, using the same scheme (waveform) and timing but with different frequencies F₁ and F₂. The mobile station receives MBS transmissions from BS #1 and BS #2 and functions to decode the MBS transmission information to yield a single MBS burst.

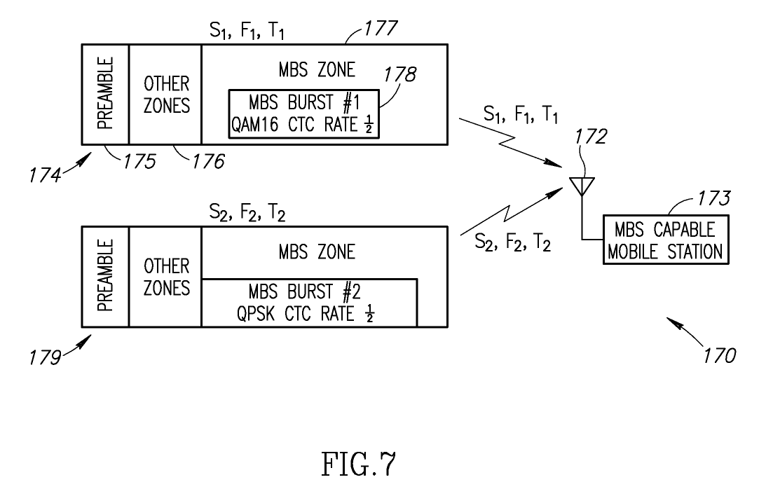

A diagram illustrating an example MBS frequency and time macro-diversity receive mechanism is shown in FIG. 7. The system, generally referenced 170, comprises an MBS capable mobile station 173 coupled to antenna 172. The system 170 shown, illustrates an example IEEE 802.16 specification based MBS implementation wherein neither the scheme S, frequency F nor timing T are coordinated (i.e. the same).

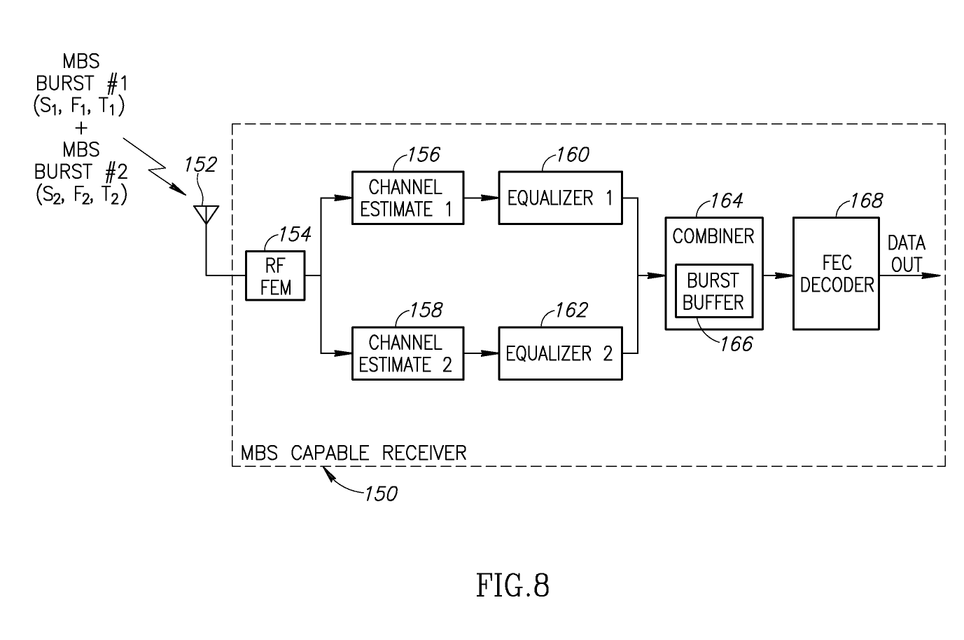

In this example two or more bursts are transmitted by two or more base stations (BS #1, BS #2) such that the coding and content are identical but transmission scheme (i.e. modulation, waveform, etc.), frequency and timing are different. This is represented in FIG. 8 as MBS burst #1 (S₁, F₁, T₁) and MBS burst #2 (S₂, F₂, T₂). In the receiver in the MS 173, each of the two MBS burst transmissions received is handled by a separate path in the receiver. As in FIG. 7, the receiver performs channel estimation and equalization separately for each MBS burst received. The signals output of each receive chain path are combined since the encoded bit stream of each MBS burst is identical, as the same information content was originally transmitted.

In operation, BS #1 (not shown) transmits within its MBS zone frame 174 comprising preamble 175, other zone information 176, MBS burst #1 178 within MBS zone 177, using transmission characteristics including scheme S₁ (QAM16, CTC rate ½), timing T₁ and frequency F₁. BS #2 (not shown) transmits the same information content within its MBS zone frame 179 comprising a preamble, other zone information, MBS burst #2 within MBS zone, using transmission characteristics including scheme S₂ (QPSK, CTC rate ½), timing T₂ and frequency F₂. Both BS #1 and BS #2 transmit the same MBS burst, i.e. Burst #1 and Burst #2, respectively, using different schemes (waveform), timing and frequencies. The mobile station receives MBS transmissions from BS #1 and BS #2 and functions to decode the MBS transmission information to yield a single MBS burst.

It is noted that the two base stations are not limited to transmitting burst(s) in the MBS zone that are related but may limit transmission to only that portion of the signal which is related to the relevant data.

A block diagram illustrating an example MBS modulation, frequency and time macro-diversity receive mechanism is shown in FIG. 8. The MBS compatible receiver, generally referenced 150, comprises an RF front end module (FEM) 154 connected to antenna 152, channel estimate 1 block 156, channel estimate 2 block 158, equalizer 1 160, equalizer 2 162, combiner 164 incorporating burst buffer 166 and forward error correction (FEC) decoder 168.

In this embodiment, two or more bursts are transmitted by two or more base stations (not shown) such that the coding and content are identical but transmission scheme (i.e. modulation, waveform, etc.), frequency and timing are different. This is represented in FIG. 7 as MBS burst #1 (S₁, F₁, T₁) and MBS burst #2 (S₂, F₂, T₂). Each of the two MBS burst transmissions received is handled by a separate path in the receiver. The receiver performs channel estimation (156, 158) and equalization (160, 162) separately for each MBS burst received (two or more) while removing the modulation. Channel estimation is needed since information signals from several sources are received. The channel estimator functions to evaluate and determine appropriate reception parameters to aid in operation of the receive path. The signals output of the equalizers are then combined via combiner 164 since the encoded bit stream of each MBS burst is identical, since the same information content was originally transmitted.

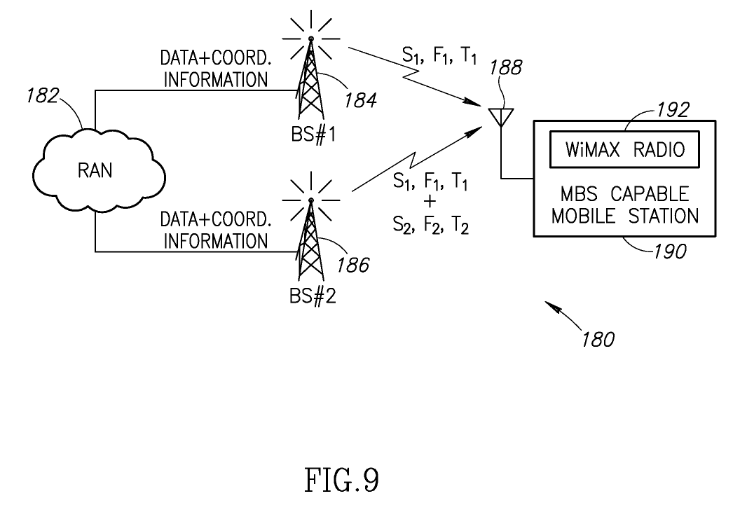

A diagram illustrating a WiMAX based MBS frequency and time macro-diversity receive mechanism is shown in FIG. 9. The system, generally referenced 180, comprises an MBS capable mobile station 190 connected to antenna 188 and including a WiMAX radio 192, radio access network (RAN) cloud 182 connected to BS #1 184 and BS #2 186 for transferring data and coordinate information.

In this alternative embodiment, the deployment scenario includes a pair of base stations participating in regular macro-diversity. Since not all cells taking part in the MBS service have identical geographic coverage, however, some cells transmit on a separate RF channel to ensure that adequate geographical cell coverage is obtained. This is represented in FIG. 9 as a burst from BS #1 with transmission characteristics (S₁, F₁, T₁) and two bursts from BS #2. The two bursts include (1) one burst with transmission characteristics (S₁, F₁, T₁) sent over a regular channel and (2) a second burst with transmission characteristics (S₂, F₂, T₂) sent over a separate RF channel.

Thus, both BS #1 and BS #2 transmit a regular macro-diversity signal while BS #2 only transmits an additional signal to compensate the larger coverage area or other coverage limitation of deployment supported by BS #2. The additional signal (S₂, F₂, T₂) may use any of the techniques described supra. The MS is aware of the transmission characteristics either by receiving unicast, multicast or broadcast information or by prior definition limiting the MS to specific behavior (e.g., definition provided by standard).

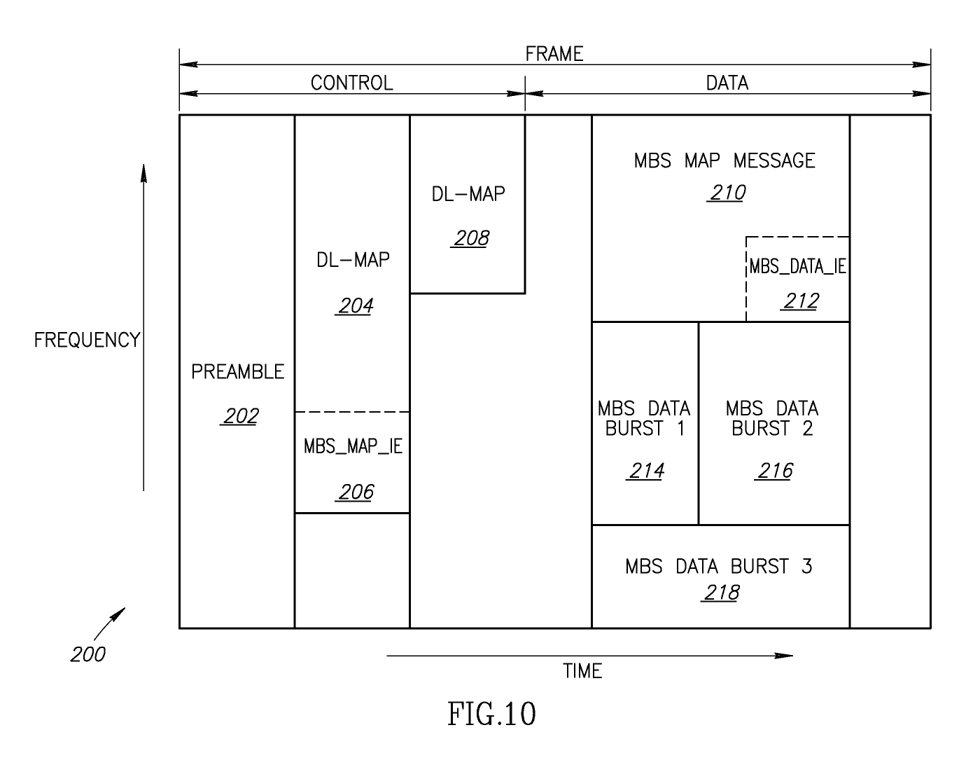

A diagram illustrating an example format of a frame including MBS-MAP and associated MBS data bursts is shown in FIG. 10. The frame, generally referenced 200, comprises a preamble 202, DL-MAP 204, 208 and MBS-MAP IE 206, MBS MAP message 210 with MBS data IE 212 and MBS data bursts 1 (214), 2 (216) and 3 (218).

In order to support MBS, the MBS-MAP message 210 was introduced into the IEEE 802.16 specification. This message, including its information elements (IEs), is transmitted to the MBS zone. The MBS-MAP message is used to notify each Multicast CID (MCID) in the MBS zone of the physical channel resources that are allocated to it. The physical channel resources include (1) one or more modulation and coding modes of the burst, which are indicated by a Downlink Interval Usage Code (DIUC), (2) power offset, which is indicated by Boosting, and (3) position of the next MBS frame. Therefore, if a mobile station correctly detects the MBS-MAP message, it can obtain the expected MBS burst corresponding to the multicast connection, the modulation and coding mode(s) used on the burst, the power offset, etc. It then can determine the position of the next MBS frame in the multicast connection, thus enabling it to receive data normally through the multicast connection.

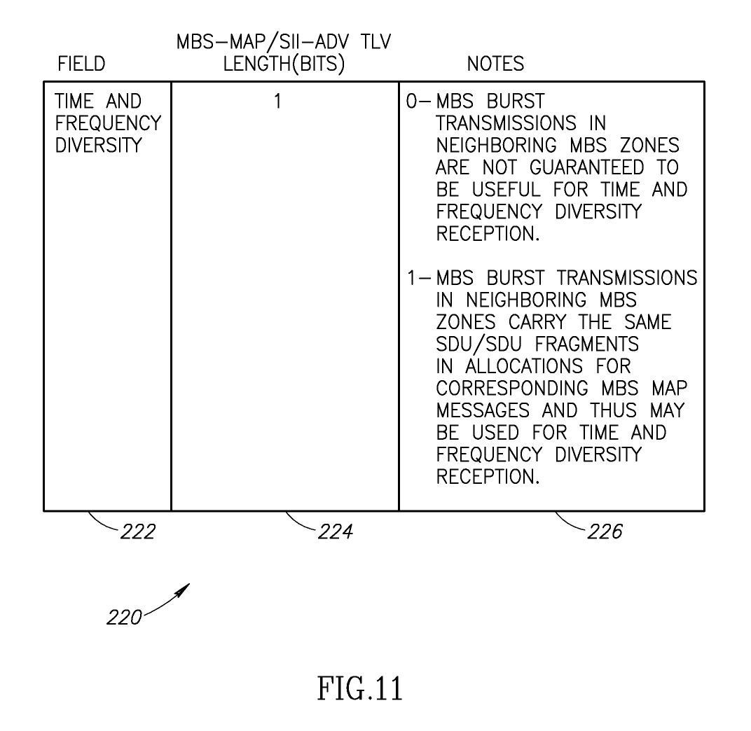

A diagram illustrating an example format of an MBS-MAP/SII-ADV TLV for indicating whether time and frequency diversity reception is valid is shown in FIG. 11. The type, length, value or TLV, generally referenced 220, comprises a field type of “Time and Frequency Diversity” 222, a length of 1-bit 224 and a value portion 226 which indicates the following for values 0 and 1:

0: indicates that MBS burst transmissions in neighboring MBS zones are not guaranteed to be useful for time and frequency diversity reception;

1: indicates that MBS burst transmissions in neighboring MBS zones carry the same service data unit (SDU)/SDU fragments in allocations for corresponding MBS MAP messages and thus may be used for time and frequency diversity reception;

This TLV can be sent as part of an information element (IE) message sent from the network (or base stations) to the mobile stations in the MBS zones. For example, it can be sent with the assignment and/or update of multicast channel IDs (MCIDs) in the MBS zones. More specifically, in the IEEE 802.16 specification, it is sent with the multicast channel ID (MCID) continuity and transmission information included in MBS-MAP and Service Identity Information advertisement (SII-ADV) messages. The TLV 220 enables time and frequency diversity even when multi-base station MBS without macro-diversity is not in use by the mobile stations utilizing the information transmitted from two or more MBS zones, as described in detail supra.

In an alternative embodiment that does not implement macro-diversity, only the border base stations need to transmit the update information. In addition, the mechanism of the present invention is backward compatible with devices that do not implement the invention. Preferably, the network, base stations and mobile stations implement the MBS macro-diversity mechanism of the present invention. Mobile stations that do not implement the mechanism and thus do not recognize the TLV 220 will simply ignore it.

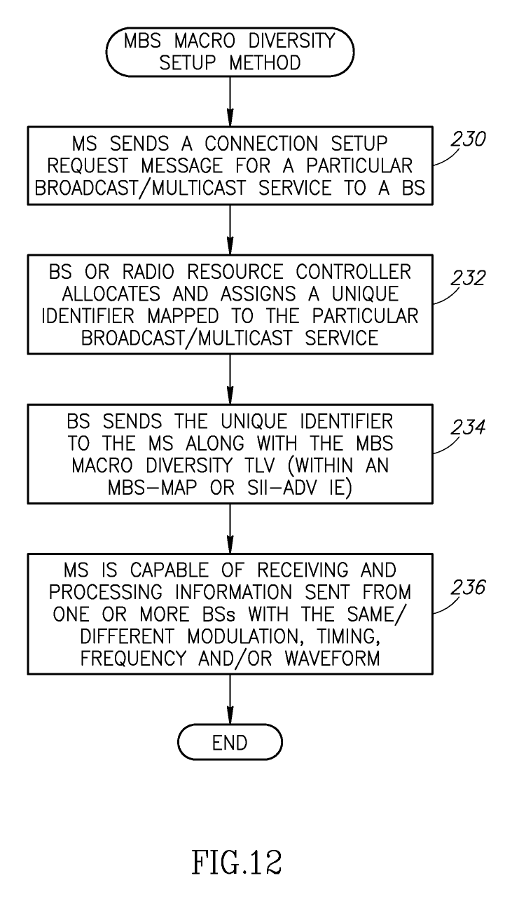

A flow diagram illustrating the MBS macro-diversity setup method of the present invention is shown in FIG. 12. The following method is used to setup the MBS macro diversity mechanism of the present invention. The mobile station sends (in response to a user command, for example) a connection setup request message for a particular broadcast/multicast service to a base station (step 230). In response, the base station (or radio resource controller) allocates and assigns a unique identifier (MCID) mapped to the particular broadcast/multicast service (step 232). The base station sends the unique identifier to the mobile station along with the MBS macro-diversity TLV (FIG. 11) indicating whether neighboring MBS transmissions can be used for time and frequency diversity in accordance with the invention (within an MBS-MAP or SII-ADV IE message) (step 234). The mobile station is then capable of using MBS transmissions sent from one or more base stations (MBS zones) with the same/different transmission characteristics (e.g., modulation, timing, frequency, waveform, etc.) for time and frequency diversity reception (step 236).

In accordance with the invention, any combination of the same or different transmission characteristics may be used to transmit MBS data to the MBS zones. In one example, transmissions may have different timing or frequency but use the same waveform. The waveform used may be defined by a central coordinating entity or may be negotiated between the base stations.

In a second example, transmissions may have different timing or frequency, use the same waveform but use different identifiers. The identifiers may be defined by a central coordinating entity or may be negotiated by the base stations.

The MBS service operation mainly comprises the following steps: (1) obtaining MBS service list information, (2) authenticating MBS service and obtaining the key, and (3) receiving the MBS service. Specifically, before reception of the MBS service, the mobile station first acquires information, such as the MBS content list, from the MBS server. It then requests a base station to authenticate the received MBS service content. After successful authentication, the base station transmits MBS downlink service parameters and other information to the mobile station. The mobile station then requests the base station to return the MBS key. When receiving the downlink service parameters and MBS key, the mobile station receives related Media Access Control Protocol Data Units (MAC PDUs) and then begins to receive normal MBS service.

As mentioned above, normal MBS service reception means receiving MBS service content with the received MBS downlink service parameters. In the current IEEE 802.16 specification, MBS downlink service parameters mainly include an MBS zone identifier and Multicast Connection ID (Multicast CID).

As described supra, the With the objects of the invention in view there is also provided, a wireless communications system, including several BSs having a radio interface for transmitting MBS data in a downlink direction; a radio resource controller connected to all BSs give unique identifiers mapped to the particular broadcast/multicast services. All BSs transmitting at arbitrary (no restrictions) transmit allocations and transmit formation and wave forms information to MS; and a combination device connected to one or more BSs and conduct mutual reception of the received signals from at least two of the transmission sources (BSs) for a modified macro-diversity reception and information processing

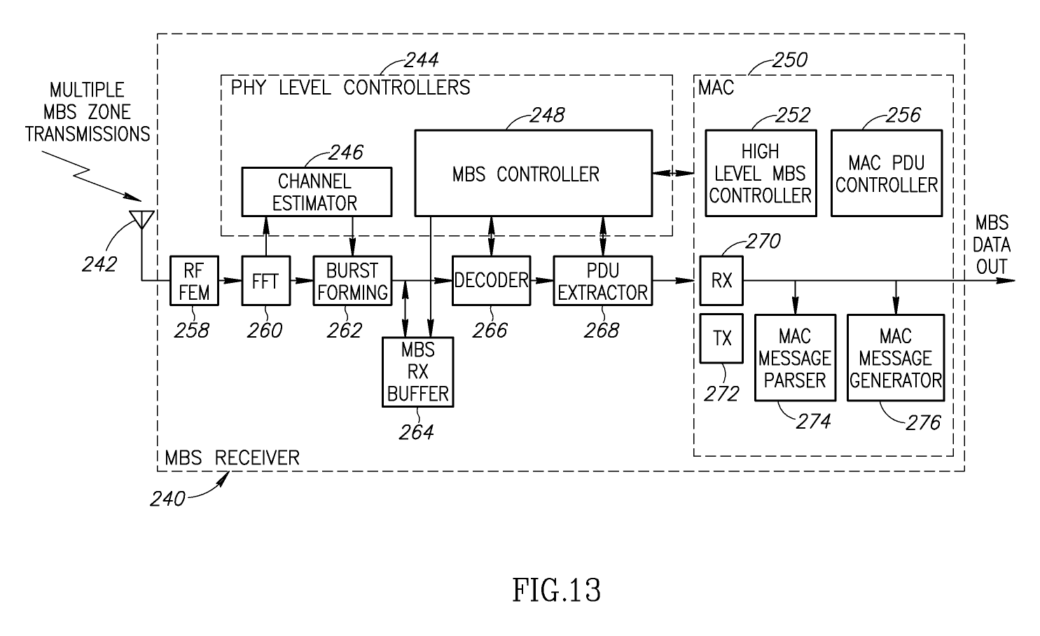

A block diagram illustrating an example MBS capable receiver constructed in accordance with the present invention is shown in FIG. 13. Note that for clarity sake, only the relevant portions of the receiver are shown. The MBS receiver, generally referenced 240, comprises an RF front end module (FEM) block 258 operative to receive an RF signal from antenna 242, FFT block 260, burst formatting block 262, decoder 266, PDU extractor block 268 operative to output MAC PDUs (MPDUs) 328 to MAC 250 and an MBS RX buffer 264.

The receiver also comprises PHY level controllers block 244 comprising channel estimation 246 which is in communication with FFT block 260 and burst formatting block 262, and MBS controller 248 which is in communication with the MBS RX buffer 264, decoder 266, PDU extractor 268 and MAC 250. The MAC 250 comprises a high level MBS controller 252, MAC PDU controller 256, TX block 272, RX block 270, MAC message parser 274 and MAC message generator 276. Note that the TX block 270 and the MAC message generator 276 are for used for configuration negotiation, connection establishment and feedback purposes.

The receiver 240 is part of an MBS capable radio interface between one or more base stations and a mobile station in a wireless communications system. The radio interface uses either a time-division multiplex (TDM), frequency-division multiplex (FDM) or frequency/time-division multiplex (FTDM) process to (1) transmit and receive on one or several frequency bands or channels to and from several transmission sources (e.g., base station) such that a plurality of transmit allocations (e.g., time slots), transmit formation and waveforms (e.g., MCS, MIMO, STC, etc.) are sent in one or more frames and (2) perform mutual reception of received signals from at least two of the transmission sources (e.g., base stations) thereby implementing modified macro-diversity reception and information processing, as described in detail supra.

In operation, the RF FEM receives the RF signal from the antenna and generates a sampled discrete baseband RF signal which is input to the time to frequency domain converter (FFT) 260 where it is converted to a frequency discrete signal. The frequency discrete signal is input to the channel estimation block 246 which functions to perform channel estimation for each source, based on the preamble series and pilots PRBS from each source. The channel estimate (CE) generated is input to the burst formatting block 262 which functions to perform the transition from the frequency domain to the logical channel domain which, together with the CE results, converts the received signal from a composed form to separate signals for each MBS transmission. These signals are then demodulated (not shown), decoded (block 266) and the PDUs extracted (block 268). The MAC PDUs are sent to the MAC 250 for MAC level processing.

Note that the receiver performs channel estimation (block 246) and equalization (not shown) separately for each MBS burst received (two or more) while removing the modulation. Channel estimation is needed since information signals from several sources are received. The channel estimator functions to evaluate and determine appropriate reception parameters to aid in operation of the receive path.

The MBS controller 248 is responsible for implementation of the MBS dedicated PHY (modem) level functionally, i.e. time and frequency diversity reception, etc. The MBS RX buffer 264 is operative to store the pre-processed information before final decoding. The MBS RX buffer is needed in receiver implementations where there is a substantial delay among the various origins of MBS transmissions.

The high level MBS controller 152 in the MAC is operative to implement the MBS dedicated MAC (high) level functionally. It is also responsible for (1) processing the control information, (2) initiation of negotiation (if needed) and (3) determining the operating mode of the receiver based on the signal and information received, system capability and current system configuration.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. As numerous modifications and changes will readily occur to those skilled in the art, it is intended that the invention not be limited to the limited number of embodiments described herein. Accordingly, it will be appreciated that all suitable variations, modifications and equivalents may be resorted to, falling within the spirit and scope of the present invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A wireless communication system, comprising:
a plurality of transmission sources operative to receive a multicast and broadcast service (MBS) data stream from an MBS server and to transmit said MBS data stream in a downlink direction in one or more MBS zones;
a radio resource controller coupled to said plurality of transmission sources and operative to provide unique identifiers mapped to particular broadcast/multicast services;
a combiner operative to receive signals from at least two transmission sources and to generate an MBS output data stream therefrom; and
wherein transmissions from all said transmission sources include the same information content and are uncoordinated with respect to each other.

2. The system according to claim 1, wherein said plurality of transmission sources comprise a plurality of base stations within a single MBS zone.

3. The system according to claim 1, wherein said plurality of transmission sources comprises a plurality of base stations (BSs) within multiple MBS zones.

4. The system according to claim 1, wherein transmissions in different MBS zones are controlled by a central coordinator.

5. The system according to claim 1, further comprising said plurality of transmission sources are operative to transmit a message to mobile stations (MSs) including an indication that MBS transmissions from neighboring base stations (BSs) within the same or different MBS zones may be used for diversity reception.

6. The system according to claim 5, wherein said indication is incorporated in an information element (IE) type, length, value (TLV).

7. The system according to claim 5, wherein said indication is incorporated in a multicast and broadcast MAP (MBS-MAP) message.

8. The system according to claim 5, wherein said indication is incorporated in a service identification information advertisement (SII-ADV) message.

9. The system according to claim 1, wherein said combiner is operative to provide time and/or frequency diversity.

10. The system according to claim 1, wherein said MBS output data stream is generated as a result of modified macro-diversity reception and information processing.

11. The system according to claim 1, wherein said combiner comprises maximum ratio combination (MRC) means to perform modified macro-diversity reception and combining.

12. The system according to claim 1, wherein said combiner comprises means for performing modified macro-diversity combining of said signals received from at least two transmission sources in layers other then the PHY layer.

13. The system according to claim 1, wherein said a plurality of transmission sources are operative to transmit identical information content having any combination of the same or different frequency domains, the same or different timing, the same or different modulation, and the same or different waveform.

14. The system according to claim 1, wherein each transmission source is operative to transmit the same information content utilizing different transmission characteristics.

15. The system according to claim 1, wherein each transmission source is operative to transmit identical information content whereby transmissions from all transmission sources are uncoordinated with respect to each other.

16. A method of providing diversity for multicast and broadcast services (MBS) in a wireless network, said method comprising the steps of:
receiving an MBS data stream from an MBS data source for transmission in a downlink direction;
transmitting a message to mobile stations (MSs) including an indication that MBS transmissions from neighboring base stations (BSs) within the same or different MBS zones may be used for diversity reception; and
transmitting MBS data signals to said mobile stations from base stations within the same MBS zone, wherein transmissions in different MBS zones include the same information content without any transmit coordination requirement therebetween.

17. The method according to claim 16, wherein transmissions in different MBS zones are controlled by a central coordinator.

18. The method according to claim 16, wherein said indication is incorporated in an information element (IE) type, length, value (TLV).

19. The method according to claim 16, wherein said indication is incorporated in a multicast and broadcast MAP (MBS-MAP) message.

20. The method according to claim 16, wherein said indication is incorporated in a service identification information advertisement (SII-ADV) message.

21. The method according to claim 16, wherein said step of combining achieves time and/or frequency diversity.

22. The method according to claim 16, wherein said step of transmitting comprises transmitting MBS data signals having identical information content having any combination of the same or different frequency domains, the same or different timing, the same or different modulation, and the same or different waveform.

23. A method of providing diversity for multicast and broadcast services (MBS) in a wireless network, said method comprising the steps of:
receiving MBS data signals from a plurality of transmission sources, wherein each transmission source transmits the same information content without any transmit coordination requirement between transmission sources; and
combining said MBS data signals and generating an MBS output data stream therefrom.

24. The method according to claim 23, wherein said MBS data signals comprise identical information content having any combination of the same or different frequency domains, the same or different timing, the same or different modulation, and the same or different waveform.

25. The method according to claim 23, wherein said plurality of transmission sources comprise a plurality of base stations (BSs) within the same MBS zone.

26. The method according to claim 23, wherein said plurality of transmission sources comprises a plurality of base stations (BSs) within the same within different MBS zones.

27. The method according to claim 23, wherein said indication is incorporated in an information element (IE) type, length, value (TLV).

28. The method according to claim 23, wherein said indication is incorporated in a multicast and broadcast MAP (MBS-MAP) message.

29. The method according to claim 23, wherein said indication is incorporated in a service identification information advertisement (SII-ADV) message.

30. The method according to claim 23, wherein said step of combining achieves time and/or frequency diversity.

31. The method according to claim 23, wherein said step of combining comprises performing modified macro-diversity reception and combining on said MBS data signals from two or more MBS zones utilizing maximum ratio combination (MRC) means.

32. The method according to claim 23, wherein said step of combining comprises performing modified macro-diversity combining of said MBS data signals from two or more base stations within the same or different MBS zones in layers other then the PHY layer.

33. A method of providing information for multicast and broadcast services (MBS) macro-diversity, said method comprising the step of:
sending a message comprising an indication of whether MBS transmissions from neighboring base stations (BSs) within the same or different MBS zones can be used for time and frequency diversity reception.

34. The method according to claim 33, wherein said message comprises a multicast and broadcast MAP (MBS-MAP) information element (IE) message.

35. The method according to claim 33, wherein said indication is incorporated in a service identification information advertisement (SII-ADV) information element (IE) message.

36. The method according to claim 33, further comprising the steps of:
in response to receipt of said message, a mobile station receiving MBS transmissions from a plurality of base stations (BSs) within the same or different MBS zones, wherein each MBS transmission comprises the same information content without any transmit coordination requirement between base stations; and
combining said MBS transmissions and generating an MBS output data stream therefrom.

37. The method according to claim 33, wherein said step of combining comprises the step of utilizing macro-diversity reception and combining techniques to generate said MBS output data stream.

38. A system for macro-diversity transmission and reception of multicast and broadcast services (MBS) in wireless network, comprising:
a transmission scheme employed by two or more base stations (BSs) in said network;
a reception scheme employed by one or more mobile stations (MSs) in said network;
one or more identifiers mapped to particular broadcast and/or multicast services; and
wherein each transmission by said base stations comprises the same information content without any transmit coordination scheme required therebetween.

39. The system according to claim 38, wherein said transmit transmission scheme is operative to transmit identical information having separate frequency domains, common timing and different waveforms.

40. The system according to claim 38, wherein said transmit transmission scheme is operative to transmit identical information having separate frequency domains, common timing and common waveforms.

41. The system according to claim 38, wherein said transmit transmission scheme is operative to transmit identical information having separate frequency domains, different timing and different waveforms.

42. The system according to claim 38, wherein said transmit transmission scheme is operative to transmit identical information having separate frequency domains, different timing and common waveforms.

43. The system according to claim 38, wherein said transmit transmission scheme is operative to transmit identical information having separate frequency domains, and/or common timing, and/or different modulation and different waveforms.

44. The system according to claim 38, wherein said transmit transmission scheme is operative to transmit identical information having separate frequency domains, and/or common timing, and/or different modulation and common waveforms.

45. A method of providing diversity for multicast and broadcast services (MBS) in a wireless network including a plurality of base stations, each base station assigned to an MBS zone, said method comprising the steps of:
each base station transmitting MBS data to one or more mobile stations in accordance with transmit characteristics associated therewith and without any synchronization between base stations; and
wherein all transmissions from all base station include the same information content.

46. The method according to claim 45, wherein said plurality of base stations transmit identical information content with transmit characteristics comprising any combination of the same or different frequency domains, the same or different timing, the same or different modulation, and the same or different waveform.

47. A mobile station, comprising:
a radio transceiver and associated media access control (MAC) operative to receive and transmit signals over a radio access network (RAN);
a multicast and broadcast services (MBS) macro-diversity module, comprising:
an MBS receiver operative to receive a plurality of MBS transmissions from a plurality of base stations (BSs) within the same or different MBS zones, wherein each base station transmits the same information content without any transmit coordination required therebetween;
a combiner operative to combine said plurality of MBS transmissions and to generate an MBS output data stream therefrom; and
a processor operative to send and receive data to and from said radio transceiver and said MBS macro-diversity module.

48. The mobile station according to claim 47, further comprising means for receiving a message comprising an indication of whether MBS transmissions in neighboring MBS zones can be used for time and frequency diversity reception.
